(19) United States
(12) Patent Application Publication
(10) Pub. No.: US 2026/0219135 A1
(43) Pub. Date: Jul. 30, 2026

(54) SYSTEM AND METHOD FOR DETECTING ISSUES IN A TURBOMACHINE BY MONITORING NOISE GENERATED BY THE TURBOMACHINE

(71) Applicant: NUOVO PIGNONE TECNOLOGIE - S.r.l., Florence (IT)

(72) Inventors: Francesco ROSSETTI, Florence, Firenze (IT); Francesco AZZINI, Florence, Firenze (IT)

(21) Appl. No.: 19/148,767

(22) PCT Filed: Jan. 23, 2024
(86) PCT No.: PCT/EP2024/025042

§ 371 Date: Jul. 17, 2025

(30) Foreign Application Priority Data
Jan. 24, 2023 (IT) 102023000000963

(51) Int. Cl. G01M 15/14

(52) U.S. Cl. CPC G01M 15/14

(57) ABSTRACT

A system comprising: at least one microphone positioned in an area where the turbomachine is installed and operates and configured to capture noise generated by the turbomachine and propagated through surrounding ambient air, an input interface configured to receive signals generated by the at least one microphone, an output interface configured to signal issues in the turbomachine once detected, and an electronic processing unit electrically coupled to the input interface and the output interface, and configured to process input signals received from the input interface and to generate output signals for the output interface; the processing of input signals comprises the steps of a) determining a sound power value from a received input signal, b) comparing the determined sound power and c) determining an output value of an output signal, the output value being related to the difference between the determined sound power and at least the first power value.

### TECHNICAL FIELD

The subject matter disclosed herein relates to systems and methods for detecting issues in a turbomachine

### Background Art

During operation of a turbomachine, its parts are subject to wear and/or to deterioration. In general, wear and deterioration lead to decrease in performances. Ultimately, the turbomachine may become damaged and/or other machines close or coupled to it may become damaged and/or the environment surrounding the turbomachines may become damaged.

Therefore, it would be desirable to have a system for detecting issues in a turbomachine, for example in Oil&Gas applications, especially before serious performance decreases and/or serious damages occur.

Furthermore, it would be desirable to detect issues in an easy way, in particular without disassembling the turbomachine, using its generated noise as known from e.g. U.S. Pat. No. 6,507,790 B1 or WO 2004/017038 A1.

According to the subject matter disclosed herein detecting an issue does not necessarily mean identifying the specific worn or deteriorated part of the turbomachine and even less identifying the root cause of the issue, even if both identifying the worn or deteriorated part and possibly the root cause would be desirable.

### SUMMARY

According to a first aspect, the subject matter disclosed herein relates to a system that allows to detect issues in a turbomachine when the turbomachine operates by monitoring noise generated by the turbomachine. The system comprises: at least one microphone positioned in an area where the turbomachine is installed and operates and configured to capture noise generated by the turbomachine and propagated through surrounding ambient air, an input interface configured to receive signals generated by the at least one microphone, an output interface configured to signal issues in the turbomachine once detected, and an electronic processing unit electrically coupled to the input interface and the output interface, and configured to process input signals received from the input interface and to generate output signals for the output interface. The processing of input signals comprises the steps of a) determining a sound power value from a received input signal, b) comparing the determined sound power at least with a first power value, and c) determining an output value of an output signal, the output value being related to the difference between the determined sound power and at least the first power value. The electronic processing unit is configured to carry out at least these steps when processing the received input signals to perform the processing of the received input signals through a set of different algorithms concurrently.

According to a second aspect, the subject matter disclosed herein relates to an issue detection method; the method allows to detect issues in a turbomachine when the turbomachine operates by monitoring noise generated by the turbomachine and propagated through surrounding ambient air; the method comprises the steps of: a) determining a sound power value from the noise generated by the turbomachine, b) comparing the determined sound power at least with a first power value, and c) determining an output, the output being related to the difference between the determined sound power and at least the first power value; preferably, a set of algorithms are used concurrently, the algorithms of said set being different or of different types.

According to a further aspect, the subject matter disclosed herein relates to a turbomachine arrangement including at least a turbomachine and an innovative issue detection system.

It is to be noted that, according to the subject matter disclosed herein, once an issue has been detected, it may be possible to take further steps and identify the specific worn or deteriorated part of the turbomachine and, possibly, to identify the root cause of the issue. In some cases the relation between the detected issue and the specific worn or deteriorated part is direct while in other cases further investigations are necessary.

### BRIEF DESCRIPTION OF THE DRAWINGS

A more complete appreciation of the disclosed embodiments of the invention and many of the attendant advantages thereof will be readily obtained as the same becomes better understood by reference to the following detailed description when considered in connection with the accompanying drawings, wherein:

FIG. 1 shows a schematic block diagram of an embodiment of an innovative issue detection system,

FIG. 2 shows a schematic block diagram of an embodiment of an innovative turbomachine arrangement, and

FIG. 3 shows a flowchart of an embodiment of an innovative issue detection method.

### DETAILED DESCRIPTION OF EMBODIMENTS

When a turbomachine operates, it produces sound emissions, i.e. acoustic waves, that are usually called “noise” as unpleasant to any human being positioned in the area where the turbomachine is installed and operates. A turbomachine may be more noisy when it has some issue, for example when a part of the turbomachine, such for example a bearing, is damaged or broken. By monitoring noise generated by the turbomachine and propagated through surrounding ambient air it is possible to detect issues in the turbomachine or at least some issues or some kinds of issues. Detecting an issue does not necessarily mean identifying the specific worn or deteriorated part of the turbomachine and even less identifying the root cause of the issue, even if both identifying the worn or deteriorated part and possibly the root cause would be desirable. The innovative system and method leverage on such consideration regarding noise generated by the turbomachine when operated and propagated through surrounding ambient air.

The above mentioned sound emissions are not to be confused with vibrations generated by the turbomachine and propagated inside the machine e.g. by parts of the machine. Sound emissions are detected by microphones remotely from the machine, while vibrations are measured by sensors mounted on the machine. Using sound emissions and using vibrations correspond to two different approaches to issues detection. The first one aims at an overall detection while the second one aims at a specific detection; for the first one only one microphone may be sufficient while for the second one several sensors are necessary. The first one may be considered less accurate than the second one; however, through the technical teachings disclosed herein an effective issues detection may be achieved through noise (i.e. sound) capturing systems being relatively simple from the hardware point of view.

Reference now will be made in detail to embodiments of the disclosure, examples of which are illustrated in the drawings. The examples and drawing figures are provided by way of explanation of the disclosure and should not be construed as a limitation of the disclosure. In fact, it will be apparent to those skilled in the art that various modifications and variations can be made in the present disclosure without departing from the scope or spirit of the disclosure. In the following description, similar reference numerals are used for the illustration of figures of the embodiments to indicate elements performing the same or similar functions. Moreover, for clarity of illustration, some references may be not repeated in all the figures.

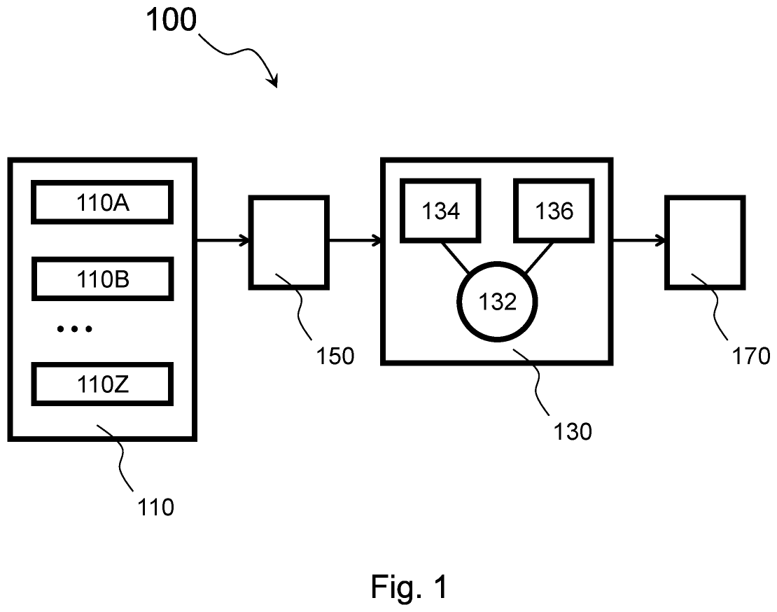

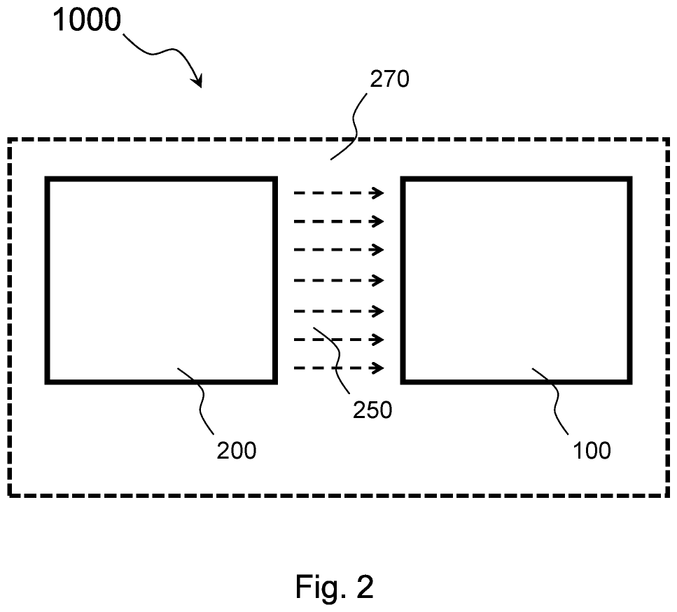

In FIG. 1, an embodiment of an innovative issue detection system 100 is shown in a schematic way. System 100 includes essentially at least one microphone 110 and an electronic processing unit 130. In FIG. 1, a plurality of microphone devices 110A, 110B, . . . 110Z are shown in order to allow a more accurate and reliable detection of issues; their number may vary from for example two to for example twenty; however, even a higher number is not to be excluded. The microphone/microphones is/are positioned in an area (see reference 270 in FIG. 2) where a turbomachine (not shown in FIG. 1) is installed and operates, and is/are configured to capture noise, i.e. acoustic waves, generated by the turbomachine and propagated through ambient air surrounding the turbomachine. Such area may be a test environment or an operative environment. The noise captured by a microphone may have a frequency in the range from 20 Hz (or even lower, e.g. 5 or 10 Hz) to 20 KHz (or even higher, e.g. 30 or 50 KHz); depending on the specific embodiment of the innovative system, the frequency range may differ, for example from 20 Hz to 20 KHz or from 20 Hz to 2 KHz or from 200 Hz to 20 KHz or from 50 Hz to 5 KHz or

It is to be noted that with the word “turbomachine” it is usually meant not only the machine processing a fluid, e.g. a compressor or an expander, but also the so-called “auxiliaries”, i.e. other secondary machines associated to the primary machine and that perform secondary functions. Noise may come from the primary machine and from the associated secondary machines and, according to some embodiments, may be captured by an innovative system.

Additionally, system 100 in FIG. 1 includes an input interface 150 electrically coupled to microphone(s) 110 and configured to receive microphone signals generated by microphone(s) 110, and an output interface 170 configured to signal issues in the turbomachine once detected.

Electronic processing unit 130 is electrically coupled to input interface 150 and output interface 170; it is configured to receive input signals from input interface 150, to process the received input signals, to generate output signals based on the received input signals, and to transmit the generated output signals to output interface 170.

The output signals are related to detected issues in the turbomachine. If no issue has been identified through the processing performed by unit 130, no output signal is generated or a specific output signal is generated carrying the information that there is no issue in the turbomachine. If an issue has been identified through the processing performed by unit 130 an appropriate output signal may be generated and sent to interface 170 for signaling to e.g. an operator for example through emitting a sound and/or emitting a light and/or a displaying a message and/or sending a data packet. If two issues have been identified through the processing performed by unit 130 two appropriate output signals may be generated and sent to interface 170 or a single output signal is generated carrying the information that there are two issues in the turbomachine.

Typically, electronic processing unit 130 is a computer or controller that includes a processor 132, data memory 134 for storing input and output data and program memory 136 for storing one or more programs. The processing performed by the processor depends on the program or programs stored in program memory 136. In general, electronic processing unit 130 includes also an input/output interface (not shown in FIG. 1) for interacting with a user. It is to be noted that the processing performed by unit 130 may depend also on input received by the user that may select for example one or more programs in program memory 136 and/or may input parameters that define at least partially the specificalities of the processing to be performed. The signals received by unit 130 from interface 150 may be digital or analog; in the latter case, an analog to digital converter circuit may be included in unit 130. The signals transmitted by unit 130 to interface 170 may be digital or analog; in the latter case, a digital to converter circuit may be included in unit 130.

Electronic processing unit 130 is configured to receive input signals, to process the received input signals, to generate output signals based on the received input signals, and to transmit the generated output signals. Such processing of input signals comprises in general the steps of:
a) determining a sound power value from a received input signal,
b) comparing the determined sound power at least with a first power value,
and
c) determining an output value of an output signal, the output value being related to the difference between the determined sound power and at least the first power value.

These are the minimum steps configured to be performed by an innovative unit when processing the received input signals. As it will be apparent form the following, advantageously, an innovative unit may be configured (for example by means of the program(s) stored in its program memory) to perform much more, in particular a set of different-type algorithms concurrently.

Indeed, the electronic processing unit 130 performs processing of the received input signals through a set of different algorithms concurrently; this means that during a same time frame (for example of 1 m or 1 s or 1 ms) processing of a same input signal according to multiple algorithms is performed. Two different algorithms may be designed to detect two different issues or to detect a same issue in different ways; in the latter case, if both algorithms bring to the conclusion that the issue is present the likelihood of issue presence is even higher, if both algorithms bring to the conclusion that the issue is not present the likelihood of issue presence is even lower, if the two algorithms bring to two different conclusions a criterion is used for deciding on the issue presence.

In general, a input signal may be divided according to successive time frames, typically of the same duration of e.g. 1 m or 1 s or 1 ms (in this case, they can be called “time periods”). A portion of an input signal corresponding to a time frame (that may be sampled at several successive time instants within the time frame and may be successively digitized) is processed according to multiple algorithms in a time frame; typically, the time frame when signal detection (and possibly sampling and possibly digitizing) occurs and the time frame when signal processing occurs are distinct, the first one preceding the second one. According to a first possibility, the algorithms are performed truly in parallel during a same time frame, i.e. they start approximately at the same time instant and end approximately at the same time instant. According to a second possibility, they are performed one after the other but still in a same time frame; so it may be said that they are practically in parallel. Raw data, for example raw data, corresponding to the input signal(s) may be temporary stored in a volatile memory to be available for concurrent processing, or to be permanently stored in a non-volatile memory such as e.g. a disk (for example for off line detailed analysis); such data, for example raw data, may be maintained in a memory until a complete diagnostic is concluded.

As said above, the algorithms of the set are of different types. For example, assuming that the set is made of two algorithms, they may operate on two distinct frequency bands (for example, two narrow bands or two wide bands or one narrow band and one wide band) (for example, two fixed bands or two variable bands or one fixed band and one variable band), they may operate considering none or one or more precedent time frames possibly in the same or different way, they may operate using two different computations (e.g. two different mathematical formulas); the possibilities of types combination are many. Using different algorithms is not to be confused with using the same computation (e.g. mathematical formula) but with different parameters. It is possible that a first algorithm performs an analysis in the frequency domain and a second algorithm performs an analysis in the time domain; analysis in the frequency domain may require applying a FFT [=Fast Fourier Transform] or DFT [=Discrete Fourier Transform] to the input signal or portion of an input signal.

When using several different algorithms, it is advantageous to assign a different importance to each of them especially, but not only, when used for detecting a same issue. A possibility is to combine the results of the algorithms through a e.g. linear combination using different weights; the above mentioned output signal (as generated or as transmitted) may be mathematically related to such combination. For example, a first algorithm may be more reliable than a second algorithm in detecting the same specific issue, but the combined use of both of them increases reliability even further. For example, a first algorithm may detect two different issues and a second algorithm may detect only one of these two different issues, so that their combined use (that may be considered a “decision criterion”) may help in choosing more reliably the occurring issue.

The electronic processing unit may be configured to perform a further algorithm based on a result (or results) of one (or more) algorithm of said set. For example, if a result appears not sufficiently reliable another algorithm may be performed afterwards. For example, if the two algorithms bring to two different conclusions, performing a third algorithm and taking its result into account may be considered a “decision criterion”.

In general, a decision criterion may also consider the security impact of the detected issue; for example, the reliable detection of a dangerous issue can cause the bypass of all the other algorithms and produce an immediate alert.

The above mentioned first power value can be for example a maximum value of sound power; in other words, the processing may consist in checking whether the power of the noise generated by the turbomachine at a certain time exceeds a predetermined value. Alternatively, the above mentioned first power value can be for example an average value of sound power; in other words, the processing may consist in checking whether the power of the noise generated by the turbomachine in a certain time frame exceeds a predetermined value.

According to an alternative, the processing performed by unit 130 may provide that at step “b” the determined sound power is compared at least with a first power value and a second power value and at step “c” the output value is related to the difference between the determined sound power and at least the first power value and/or the second output value. For example, the first power value may correspond to an expected average of the noise power plus an expected variance of the noise power and the second power value may correspond to an expected average of the noise power minus an expected variance of the noise power; in other words, the processing may consist in checking whether the power of the noise generated by the turbomachine at a certain time on in a certain time frame lies within a predetermined power range.

At step “c”, the output value may be a binary value; an issue is either detected (for example the noise level is above a certain threshold) or non-detected (for example the noise level is below a certain threshold). Alternatively, the output value may be a multiple value or a continuous value; for example, the output value corresponds to the difference between the determined sound power and the first power value or to a discretization of such difference; in this case, the output value may indicate a severity of the issue.

At step “c”, the output value may be related to the difference between the determined sound power and at least the first power value within a time frame; in other words, the processing may consist in checking whether the power of the noise generated by the turbomachine exceeds a predetermined value for a certain amount of time, i.e. within a time frame. This is useful, for example, in order to avoid considering momentaneous or short noise peaks.

At step “a”, the sound power value may be determined from a bandwidth of a received input signal; in other words, before performing the processing of an input signal by the electronic processing unit, the input signal may be filtered, specifically may band-pass filtered. This is useful, for example, in order to avoid considering frequencies that cannot be due to a certain issue of the turbomachine under observation or to a certain kind of issues of the turbomachine under observation.

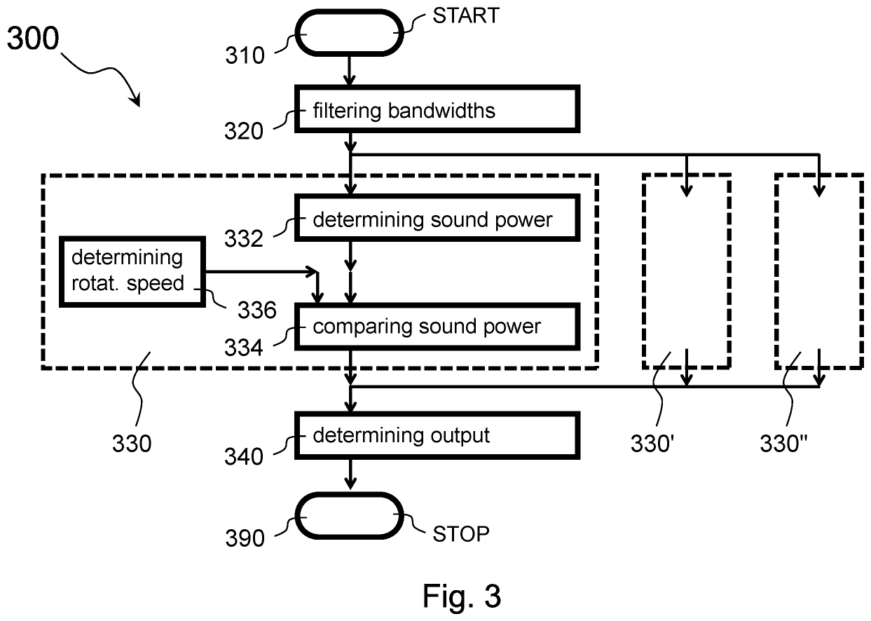

Advantageously, the received input signal may be filtered by a set of band-pass filters and for each bandwidth a distinct processing (through a same algorithm or through different algorithms) is performed (see the embodiment of FIG. 3, in particular block 320 and blocks 330, 330′ and 330″), in particular a distinct sound power value is determined. This is useful, for example, in cases where a first issue causes noise in a first fixed and predetermined bandwidth and a second issue causes noise in a second fixed and predetermined bandwidth; the two issues may be considered to have two different “acoustic signatures” and the same algorithm is used for determining an acoustic signature and comparing it with known acoustic signatures (as in U.S. Pat. No. 6,507,790 B1).

According to some embodiments, the system may be configured to determine a current rotation speed of the turbomachine (see the embodiment of FIG. 3, in particular block 336), and the processing of the inputs signals may depend on the determined current rotation speed. This is useful, for example, when monitoring a turbomachine; in fact, in this case, the noise normally generated during normal operation has peaks at a first frequency corresponding to the rotation speed, at a second frequency corresponding to twice the rotation speed, etc., and it is desirable not to confuse “normal noise” with “issue noise”; in this case, the normal noise” may be filtered out. Of course, the processing becomes more complicated if a variable rotation speed of the turbomachine is to be considered. Determination of the rotation speed may derive from a rotation speed sensor associated to the turbomachine, or from an input signal coming from a system that is associated to the turbomachine and that knows the rotation speed, or from a piece of software that processes an input signal (for example a sound input signal from a microphone devices suitable positioned).

The first power value and/or the second power value may depend on the determined current rotation speed; in other words, the comparison at step “b” may be adjusted so to take into account the “normal noise” due to rotation.

Such adjustment may vary from time to time, i.e. may vary as the rotation speed of the turbomachine varies. An algorithm considering rotation speed is of a different type than an algorithm disregarding rotation speed.

Advantageously, at step “a”, the received input signal is preliminary filtered by suppressing ambient noise. Ambient noise may be determined through e.g. at least one microphone device suitably positioned and oriented.

The processing of received input signals by the electronic processing unit may be performed though a plurality of different algorithms in parallel. This may be useful if you are interested in detected different specific issues or specific kinds of issue in the same turbomachine. The various algorithms may have different importance, for example different weights in complex diagnostic system. One or more of the algorithms may be dedicated or take into account for example to noise generated by so-called “auxiliaries”.

Advantageously, the system may be configured to determine a current operating mode of the turbomachine or a current operating mode of an arrangement including the turbomachine, and the processing of received input signals by the electronic processing unit may depend on the determined current operating mode. This is useful as a turbomachine or a turbomachine arrangement generates a different “normal noise” in a different operating mode. If the operating mode is known (in some way, for example from an input signal received from a turbomachine control unit) it is easier not to confuse “normal noise” with “issue noise”. The algorithms used for processing the received input signals may depend for example on a current operating mode; for example, one or more algorithms are used in a first operating mode and one or more algorithms are used in a second operating mode; one or more algorithms are used in both operating modes.

Advantageously, the system may be configured to determine a current operating mode of the turbomachine or a current operating mode of an arrangement including the turbomachine, and the signaling by the system may depend on the determined current operating mode. This is useful as in a first operating mode a certain noise may be considered “normal” while as in a second operating mode the same noise may be considered an “issue”.

It may be provided that in one or more operating modes, signaling of issues is disabled. More in general, signaling of issues may be different from operating mode to operating mode.

Advantageously, the electronic processing unit may be configured to determine at least a specific issue in the turbomachine from noise generated by the turbomachine, and the signaling by the system may include information regarding at least the specific issue. In fact, it is to be expected that one or more specific issues are easier to be determined while for other issues they may be simply detected but not determined.

As mentioned at the beginning of the detailed description, the innovative system may comprises a set of (identical or different) microphones; for example, system 100 in FIG. 1 comprises a set of microphone devices 110A, 110B and 110Z. The microphones may be appropriately positioned and/or oriented with respect to the turbomachine, typically each of them remote (e.g. at a distance of 1-10 m) from the turbomachine or noisy components of the turbomachines (in general, the distance is not the same for each microphone). As already mentioned, there may be an additional microphone dedicated to detecting ambient noise. It is possible that one or more dedicated algorithms can be used to extract ambient noise from the signal(s) of microphone(s) without the use of dedicated microphones.

In this case, the signals from these microphone devices may be appropriately processed and/or combined by the input interface and/or the electronic processing unit.

In general, the electronic processing unit may be pre-trained. Training may relate to the specific turbomachine or turbomachine arrangement to be monitored and/or the specific issue or kind of issue to be detected and/or the specific issue or kind of issue to be determined; it is to be noted that this may apply to a plurality of specific issues or kinds of issues. Training may also relate to the different delays and/or phase shifts and/or amplification or attenuation used for processing signals coming from distinct microphones; this is particularly important if the noise generated by a turbomachine may be considered as coming from distinct noise sources located at (relatively) distant points; in other words, training considering the specific positioning of the microphones and/or specific positioning of the noise sources; it is to be noted that such training may be repeated for different frequencies of the generated noise or for different frequency bandwidths of the generated noise; it is to be noted that such training may be repeated for different operating modes of the turbomachine to be observed.

An innovative issue detection system may be associated to a turbomachine. In this case, as shown in FIG. 2, we may consider an innovative turbomachine arrangement 1000 comprising a turbomachine 200 and a system 100 for detecting issues in turbomachine 200 when turbomachine 200 operates by monitoring noise (schematically indicated with arrows 250 in FIG. 2) generated by turbomachine 200 in a (closed or open) area 270 where turbomachine 200 is installed and operates. Preferably, only one turbomachine should be associated to an innovative issue detection system as, otherwise, it would be difficult for the system to understand which is the turbomachine subject to an issue.

As already mentioned, according to an aspect, the subject matter disclosed herein relates to an issue detection method; the method allows to detect issues in a turbomachine when the turbomachine operates by monitoring noise generated by the turbomachine; as already mentioned, the method comprises at least the steps of: a) determining a sound power value from the noise generated by the turbomachine, b) comparing the determined sound power at least with a first power value, and c) determining an output, the output being related to the difference between the determined sound power and at least the first power value.

FIG. 3 shows a flowchart 300 incorporating an embodiment of the innovative method. The method starts at a START block 310 and ends at a STOP block 390. Block 310 may provide for the reception of one (or more) input signal from a microphone device or we may assume that one (or more) input signal has already been received before the start of the method of FIG. 3. Block 390 may provide for the transmission of an output signal or we may assume that an output signal will be transmitted after the end of the method of FIG. 3.

According to the embodiment of FIG. 3, the input signal is optionally filtered by three band-pass filters with three different bandwidths (block 320). The output of each filter is processed, preferably in parallel, preferably in two or three different ways, respectively by a block 330 and a block 330′ and a block 330″; only one these three block is shown in detail in FIG. 3.

After blocks 330 and 330′ and 330″, controls goes to block 340 corresponding to the determination of the output value regarding the issue detection. In the case of the embodiment of FIG. 3, determination is based on the output of the processing from blocks 330 and 330′ and 330″.

In block 330, there is provided the step of determining (block 332) a sound power value from the noise generated by the turbomachine and the step of comparing (block 334) the determined sound power at least with a first power value.

In the embodiment of FIG. 3, there is also provided the step of determining (block 336) the rotation speed of the turbomachine and using such information at the comparison step (block 334).

In the embodiment of FIG. 3, for example, the processing in blocks 330′ and 330″ may not be based on rotation speed determination contrary to block 330. According to embodiments alternative to the one of FIG. 3, the processing in blocks 330′ and 330″ may be based even on a same bandwidth or on overlapping bandwidths.

1. A system for detecting issues in a turbomachine when the turbomachine operates by monitoring noise generated by the turbomachine, wherein the system comprises:
at least one microphone positioned in an area where the turbomachine is installed and operates, the at least one microphone being configured to capture noise generated by the turbomachine and propagated through ambient air,
an input interface electrically coupled to the least one microphone, the input interface being configured to receive signals generated by the at least one microphone,
an output interface configured to signal issues in the turbomachine once detected, and
an electronic processing unit electrically coupled to the input interface and the output interface, the electronic processing unit being configured to receive input signals from the input interface, to process the received input signals, to generate output signals based on the received input signals, and to transmit the generated output signals to the output interface, the output signals being related to detected issues in the turbomachine; wherein the electronic processing unit is configured so that when processing the received input signals:
a) to determine a sound power value from a received input signal,
b) to compare the determined sound power at least with a first power value, and
c) to determine an output value of an output signal, the output value being related to the difference between the determined sound power and at least the first power value;
wherein the processing of the received input signals by the electronic processing unit is performed through a set of algorithms concurrently, the algorithms of said set being of different

2. The system of claim 1, wherein the algorithms of said set have a different importance, in particular a different weight, in the generation of an output signal and/or in the transmission of an output signal.

3. The system of claim 1, wherein the electronic processing unit is configured to perform a further algorithm based on a result of an algorithm of said set.

4. The system of claim 1, wherein the output value is related to the difference between the determined sound power and at least the first power value within a time frame.

5. The system of claim 1, wherein the sound power value is determined from a bandwidth of a received input signal.

6. The system of claim 1, wherein the system is configured to determine a current rotation speed of the turbomachine, and wherein the processing of the received input signals depends on the determined current rotation speed.

7. The system of claim 1, wherein the system is configured to determine a current operating mode of the turbomachine or a current operating mode of an arrangement including the turbomachine, and wherein the processing of the received input signals by the electronic processing unit depends on the determined current operating mode.

8. The system of claim 1, wherein the electronic processing unit is configured to determine at least a specific issue in the turbomachine from noise generated by the turbomachine, and wherein signaling by the system includes information regarding at least the specific issue.

9. The system of claim 1, wherein the determined sound power is compared at least with a first power value and a second power value, and wherein the output value is related to the difference between the determined sound power and at least the first power value and/or the second output value.

10. The system of claim 5, wherein additional sound power values are determined from other bandwidths of the received input signal.

11. The system of claim 6, wherein the first power value and/or the second power value depend on the determined current rotation speed.

12. The system of claim 1, wherein the received input signals are preliminary filtered by suppressing ambient noise.

13. The system of claim 12, wherein ambient noise is determined through at least one microphone.

14. The system of claim 1, wherein the system is configured to determine a current operating mode of the turbomachine or a current operating mode of an arrangement including the turbomachine, and wherein signaling by the system depends on the determined current operating mode.

15. The system of claim 14, wherein signaling is disabled in one or more operating modes.

16. The system of claim 1, wherein the system comprises a set of microphones.

17. The system of claim 1, wherein the electronic processing unit is pre-trained.

18. A turbomachine arrangement comprising:
a turbomachine, and
a system for detecting issues in the turbomachine when the turbomachine operates by monitoring noise generated by the turbomachine and propagated through ambient air, wherein the system has the features set out in claim 1.

19. A method for detecting issues in a turbomachine when the turbomachine operates by monitoring noise generated by the turbomachine, wherein the method comprises the steps of:
a) determining a sound power value from the noise generated by the turbomachine and propagated through ambient air,
b) comparing the determined sound power at least with a first power value, and c) determining an output, the output being related to the difference between the determined sound power and at least the first power value; wherein preferably a set of algorithms are used concurrently, the algorithms of said set being different or of different types.
